(19) United States
(12) Patent Application Publication
(10) Pub. No.: US 2024/0376681 A1
(43) Pub. Date: Nov. 14, 2024

(54) GROUND SHAFT INCLUDING SIDE WALLS CONFIGURED TO PROVIDE ENHANCED LOAD-BEARING CAPACITY

(71) Applicant: PPC BROADBAND, INC., East Syracuse, NY (US)

(72) Inventors: Peter BITTMANN, Berlin (DE); Horst HUKE, Walsrode (DE); Ricky SELLE, Leipzig (DE)

(73) Assignee: PPC BROADBAND, INC., East Syracuse, NY (US)

(21) Appl. No.: 18/662,695

(22) Filed: May 13, 2024

(30) Foreign Application Priority Data
May 12, 2023 (DE) 102023112636.9

(51) Int. Cl. E02D 29/05

(52) U.S. Cl. CPC E02D 29/05

(57) ABSTRACT

A frame portion may be configured to provide enhanced load-bearing capacity for a ground shaft that is configured to delimit a cavity. The frame portion may include a first longitudinal wall portion and a second longitudinal wall portion, and a first lateral wall portion and a second lateral wall portion configured to be coupled with the first longitudinal wall portion and a second longitudinal wall portion. At least a portion of the first longitudinal wall portion may comprise plastic. The first longitudinal wall portion may include a tensioning portion structurally configured to counteract a deformation force acting on an exterior side portion of the first longitudinal wall in a direction toward an interior of the frame portion so as to enhance load-bearing capacity of the first longitudinal wall portion.

### CROSS-REFERENCE TO RELATED APPLICATION

This application claims the benefit of German Patent Application No. 10 2023 112 636.9, filed May 12, 2023, the contents of which are incorporated herein by reference.

### TECHNICAL FIELD

The present disclosure relates to a ground shaft configured to delimit a cavity in the ground and, more particularly, a ground shaft having a side wall portion structurally configured to provide enhanced load-bearing capacity.

### BACKGROUND

Such devices are often referred to as underground shafts or ground shafts. Typically, such devices have a cuboid interior and a cover. Such devices are often arranged in the area of footpaths or streets. Branching elements or connecting elements of supply networks are often arranged in the interior spaces of the devices. For example, these can be components of a communication network or an energy supply network.

In some conventional ground shafts, both the side walls and the cover of such devices are made of concrete. However, some conventional ground shafts are made of plastic. For example, some conventional ground shafts include side walls comprising individual plastic modules that are configured to be connected to one another. Such devices are described, for example, in WO 2017/025077 A1, DE 10 2010 050 964 B3, and DE 10 2012 101 366 B3, the contents of which are incorporated herein by reference.

With regard to mechanical stability, such ground shafts must be able to withstand being run over by vehicles, but the devices are also subjected to lateral loads if a vehicle drives over the ground area offset to the side of the ground shaft and vertical stresses are converted into horizontal stresses by the ground. In particular, in the case of ground shafts made of plastic, with such lateral loads there is a risk that the side walls may be deformed towards an interior of the device to an extent that the construction is damaged.

Accordingly, it may be desirable to provide a ground shaft including a side wall portion configured to provide enhanced load-bearing capacity.

### SUMMARY

According to an exemplary embodiment of the disclosure, a ground shaft may be structurally configured to delimit a cavity and provide enhanced load-bearing capacity. The ground shaft may include a first longitudinal wall portion and a second longitudinal wall portion configured to be spaced apart from one another and extend parallel to one another in a longitudinal direction, and a first lateral wall portion and a second lateral wall portion may be configured to be spaced apart from one another in the longitudinal direction and extend parallel to one another in a transverse direction that is perpendicular to the longitudinal direction. The first longitudinal wall portion may be configured to be coupled with first ends of the first and second lateral wall portions, and opposing ends of the second longitudinal wall portion may be configured to be coupled with second ends of the first and second lateral wall portions, and the first longitudinal wall portion may include a tensioning portion and a receiving portion that is configured to receive the tensioning portion. The first ends of the first and second lateral wall portions may be structurally configured to anchor opposing ends of the tensioning portion, the tensioning portion may be configured to include an adjusting portion that is structurally configured to pretension the tensioning portion, at least a portion of the first longitudinal wall portion may comprise plastic, and the tensioning portion may comprise metal. The tensioning portion may be structurally configured to counteract a deformation force acting on an exterior side portion of the first longitudinal wall in a direction toward an interior of the ground shaft so as to enhance load-bearing capacity of first longitudinal wall portion.

In some embodiments of the foregoing ground shaft, the receiving portion may comprise a groove in a top surface of the first longitudinal wall portion that is configured to curve toward the interior of the ground shaft so as to pretension the tensioning portion received therein.

In some embodiments of the foregoing ground shafts, the adjusting portion may be configured to generate a force directed outwards from the interior of the ground shaft.

In some embodiments of the foregoing ground shafts, the second longitudinal wall portion may include a second tensioning portion and a receiving portion that is configured to receive the second tensioning portion, the second ends of the first and second lateral wall portions may be structurally configured to anchor opposing ends of the second tensioning portion, the second tensioning portion may be configured to include an adjusting portion that is structurally configured to pretension the second tensioning portion, at least a portion of the second longitudinal wall portion may comprise plastic, the second tensioning portion may comprises metal, and the second tensioning portion may be structurally configured to counteract a deformation force acting on an exterior side portion of the second longitudinal wall in a direction toward the interior of the ground shaft so as to enhance load-bearing capacity of second longitudinal wall portion.

In some embodiments of the foregoing ground shafts, the first and second longitudinal wall portions and the first and second lateral wall portions are configured to be coupled with one another to form a continuous frame portion.

In some embodiments of the foregoing ground shafts, a second frame portion may be configured to be stacked with the frame portion, and the second frame portion may have first and second longitudinal wall portions and first and second lateral wall portions that are the same as the first and second longitudinal wall portions and the first and second lateral wall portions, respectively, of the frame portion.

According to an exemplary embodiment of the disclosure, a frame portion may be configured to provide enhanced load-bearing capacity for a ground shaft that is configured to delimit a cavity. The frame portion may include a first longitudinal wall portion and a second longitudinal wall portion configured to be spaced apart from one another and extend parallel to one another in a longitudinal direction, and a first lateral wall portion and a second lateral wall portion configured to be spaced apart from one another in the longitudinal direction and extend parallel to one another in a transverse direction that is perpendicular to the longitudinal direction. Opposing ends of the first longitudinal wall portion may be configured to be coupled with first ends of the first and second lateral wall portions, and opposing ends of the second longitudinal wall portion may be configured to be coupled with second ends of the first and second lateral wall portions. At least a portion of the first longitudinal wall portion may comprise plastic. The first longitudinal wall portion may include a tensioning portion structurally configured to counteract a deformation force acting on an exterior side portion of the first longitudinal wall in a direction toward an interior of the frame portion so as to enhance load-bearing capacity of the first longitudinal wall portion.

In some embodiments of the foregoing frame portions, the first longitudinal wall portion may be configured to include a receiving portion that is configured to receive the tensioning portion.

In some embodiments of the foregoing frame portions, the receiving portion may comprise a groove in a top surface of the first longitudinal wall portion that is configured to curve toward the interior of the frame portion so as to pretension the tensioning portion received therein.

In some embodiments of the foregoing frame portions, first ends of the first and second lateral wall portions are structurally configured to anchor opposing ends of the tensioning portion.

In some embodiments of the foregoing frame portions, the tensioning portion comprises metal.

In some embodiments of the foregoing frame portions, the tensioning portion comprises plastic having greater tensile strength than the plastic of the first longitudinal wall portion.

In some embodiments of the foregoing frame portions, the tensioning portion is configured to include an adjusting portion that is structurally configured to pretension the tensioning portion. In some aspects, the adjusting portion is configured to generate a force directed outwards from the interior of the ground shaft.

In some embodiments of the foregoing frame portions, the second longitudinal wall portion includes a second tensioning portion, and the second tensioning portion is structurally configured to counteract a deformation force acting on an exterior side portion of the second longitudinal wall in a direction toward the interior of the frame so as to enhance load-bearing capacity of second longitudinal wall portion.

In some embodiments of the foregoing frame portions, wherein opposing ends of the first longitudinal wall portion are configured to be coupled with first ends of the first and second lateral wall portions, and opposing ends of the second longitudinal wall portion are configured to be coupled with second ends of the first and second lateral wall portions to form a continuous frame portion.

In some aspects, a ground shaft may include one of the foregoing frame portions and may further include a second frame portion configured to be stacked with the frame portion. The second frame portion may have first and second longitudinal wall portions and first and second lateral wall portions that are the same as the first and second longitudinal wall portions and the first and second lateral wall portions, respectively, of the frame portion.

According to an exemplary embodiment of the disclosure, a frame portion may be configured to provide enhanced load-bearing capacity for a ground shaft that is configured to delimit a cavity. The frame portion may include a first longitudinal wall portion and a second longitudinal wall portion, and a first lateral wall portion and a second lateral wall portion configured to be coupled with the first longitudinal wall portion and a second longitudinal wall portion. At least a portion of the first longitudinal wall portion may comprise plastic. The first longitudinal wall portion may include a tensioning portion structurally configured to counteract a deformation force acting on an exterior side portion of the first longitudinal wall in a direction toward an interior of the frame portion so as to enhance load-bearing capacity of the first longitudinal wall portion.

In some embodiments of the foregoing frame portions, the first longitudinal wall portion may be configured to include a receiving portion that is configured to receive the tensioning portion.

In some embodiments of the foregoing frame portions, the receiving portion may comprise a groove in a top surface of the first longitudinal wall portion that is configured to curve toward the interior of the frame portion so as to pretension the tensioning portion received therein.

In some embodiments of the foregoing frame portions, first ends of the first and second lateral wall portions are structurally configured to anchor opposing ends of the tensioning portion.

In some embodiments of the foregoing frame portions, the tensioning portion comprises metal.

In some embodiments of the foregoing frame portions, the tensioning portion comprises plastic having greater tensile strength than the plastic of the first longitudinal wall portion.

In some embodiments of the foregoing frame portions, the tensioning portion is configured to include an adjusting portion that is structurally configured to pretension the tensioning portion. In some aspects, the adjusting portion is configured to generate a force directed outwards from the interior of the ground shaft.

In some embodiments of the foregoing frame portions, the second longitudinal wall portion includes a second tensioning portion, and the second tensioning portion is structurally configured to counteract a deformation force acting on an exterior side portion of the second longitudinal wall in a direction toward the interior of the frame so as to enhance load-bearing capacity of second longitudinal wall portion.

In some embodiments of the foregoing frame portions, wherein opposing ends of the first longitudinal wall portion are configured to be coupled with first ends of the first and second lateral wall portions, and opposing ends of the second longitudinal wall portion are configured to be coupled with second ends of the first and second lateral wall portions to form a continuous frame portion.

In some aspects, a ground shaft may include one of the foregoing frame portions and may further include a second frame portion configured to be stacked with the frame portion. The second frame portion may have first and second longitudinal wall portions and first and second lateral wall portions that are the same as the first and second longitudinal wall portions and the first and second lateral wall portions, respectively, of the frame portion.

The foregoing and other features of construction and operation of the invention will be more readily understood and fully appreciated from the following detailed disclosure, taken in conjunction with accompanying drawings.

### BRIEF DESCRIPTION OF THE DRAWINGS

FIG. 1 is a perspective view of an exemplary reusable cable reel in accordance with various aspects of the disclosure.

FIG. 2 is a plan view of the device according to FIG. 1,

FIG. 3 is an enlarged representation of a detail,

FIG. 4 is a further enlarged representation of a detail,

FIG. 5 is an enlarged perspective view of a side wall module in the area of a clamping element,

FIG. 6 is an enlarged representation of a horizontal section in a corner area of the device,

FIG. 7 is a side view of a vertical section through a side wall,

FIG. 8 is a side view of a side wall,

FIG. 9 is a horizontal section through a side wall,

FIG. 10 is a plan view of a side wall,

FIG. 11 is a perspective partial representation of a side wall,

FIG. 12 is an enlarged representation of a detail,

FIG. 13 is a further enlarged representation of a detail,

FIG. 14 is a perspective representation of a device composed of several wall modules,

FIG. 15 illustrates the device according to FIG. 14 with an attached cover,

FIG. 16 illustrates the device according to FIG. 15 in an exploded view,

FIG. 17 illustrates a further exploded view of the device, and

FIG. 18 is a partially sectioned representation of the device according to FIG. 15.

### DETAILED DESCRIPTION OF EMBODIMENTS

As a preface to the detailed description, it should be noted that, as used in this specification and the appended claims, the singular forms “a,” “an,” and “the” include plural referents, unless the context clearly dictates otherwise.

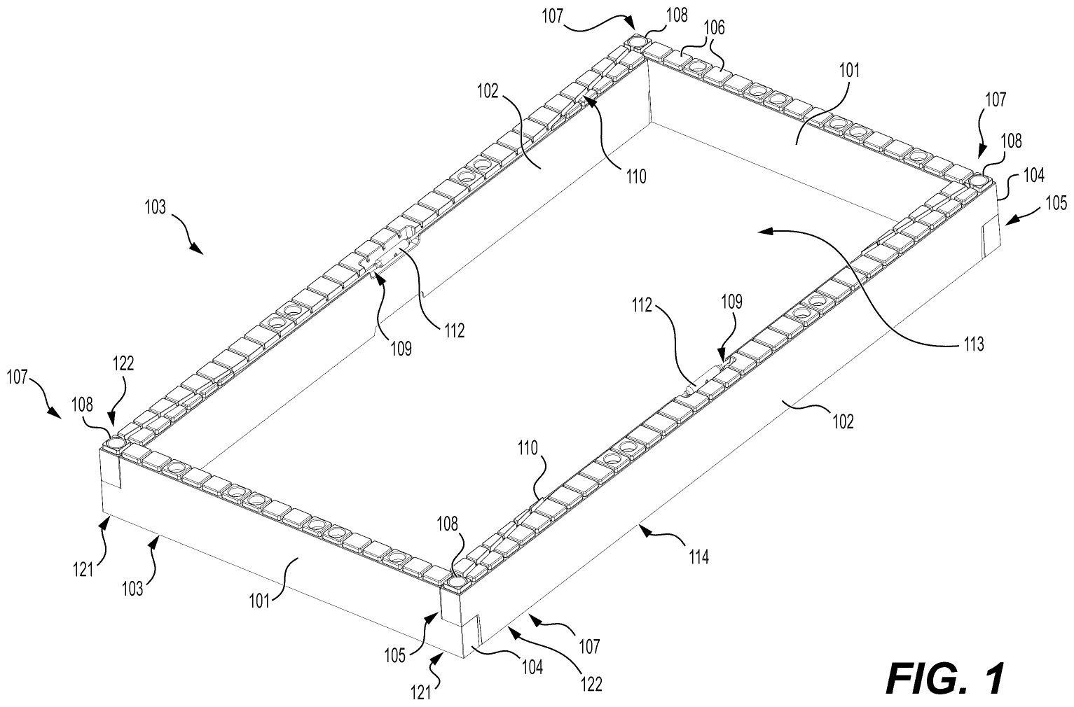

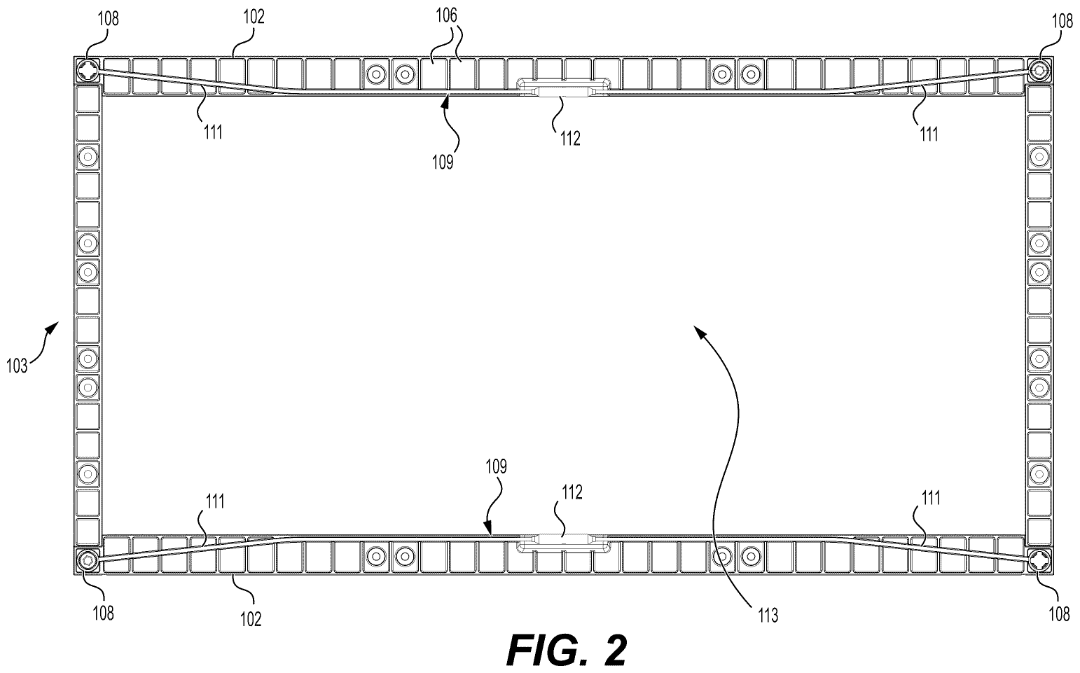

FIG. 1 shows a perspective view of part of a device 100 for delimiting a cavity in the ground, which may be generally referred to as a ground shaft or an underground shaft. As shown in FIGS. 1 and 2, the ground shaft 100 may include a longitudinal portion 102, for example, two longitudinal segments, and a transverse portion 101, for example, two transverse segments. In the illustrated embodiment, the transverse segments 101 and the longitudinal segments 102 are combined to form a frame portion 103, for example, a rectangular frame. In order to facilitate this type of assembly, the transverse segments 101 have a receiving portion 104, for example, recesses, and a coupling portion 105, for example, projections, at their end portions 121. A corresponding design is also implemented at end portions 122 of the longitudinal segments 102. As a result, the transverse segments 101 and the longitudinal segments 102 can be joined together at their end portions 121, 122. The transverse segments 101 and the longitudinal segments 102 may be referred to as wall modules of the ground shaft.

An engaging portion 106, for example, a plurality of elevations, may be arranged at upper side portions of the transverse segments 101 and the longitudinal segments 102, respectively. When one or more frames 103 are arranged one above the other, the engaging portion 106, for example, the elevations, may engage in an engaging portion receiving portion, for example, depressions, in underside portions of the transverse segments 101 and the longitudinal segments 102. As a result, when the frames 103 are coupled together, a form fit and/or a force fit between coupled transverse segments 101 and coupled longitudinal segments 102 can be achieved.

A corner portion 107, for example, the four corners of the illustrated frame 103, may include a bearing portion or load bearing portion 108, for example, bearing elements. The bearing elements 108 extend in a vertical direction and connect the end portions 121 of the transverse segments 101 with the end portions 122 of the longitudinal segments. The bearing elements 108 may comprise bolts, cylinders, tubes, or the like, for example. In some embodiments, the bearing elements may comprise a metal, for example, steel, and the transverse segments 101 and the longitudinal segments 102 may comprise a plastic.

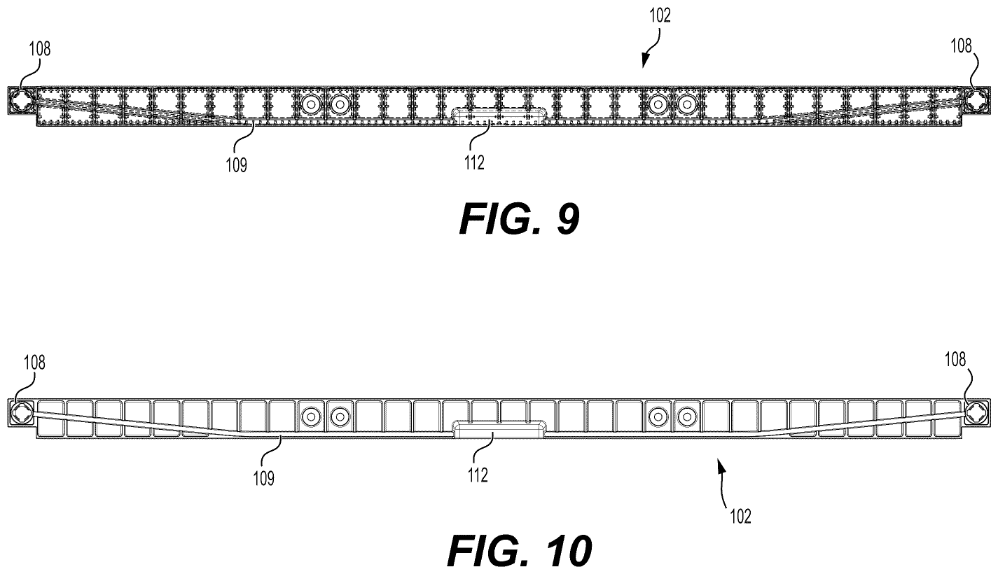

As best shown in FIGS. 1, 2, 6, 9, and 10, the longitudinal segments 102 include a tensioning portion receiving portion 110, for example, a groove, in upper side portions of the longitudinal segments 102. It should be understood that in some aspects, the tensioning portion receiving portion 110 may be configured as a channel or cavity. The tensioning portion receiving portion 110 is configured to receive a tensioning portion 109, for example, rope-like tensioning members. As illustrated, the tensioning members 110 may be arranged in the recesses 110 in the longitudinal segments 102. In the illustrated embodiment, the tensioning portion receiving portion 110 is configured as a curved groove so as to pretension the tensioning portion, as would be understood by persons skilled in the art. End portions of the tensioning members 109 are fixed at an area of the bearing elements 108. In some embodiments, the tensioning members 109 may comprise steel wires, and such tensioning members 109 may be fixedly attached to the bearing elements 108, for example, via welding, as shown in FIG. 6. In some aspects, the tensioning members may be made of sufficiently strong plastics.

Referring again to FIGS. 1, 2, and 5, each of the tensioning members 109 may comprise two tensioning segments 111 that are connected to one another by an adjusting portion 112, for example, a turnbuckle, stretching screw, bottle screw, or the like, that is configured to adjust the tension of the tensioning member 109. In the illustrated embodiment, the tensioning portion receiving portion 110 is configured as a curved groove that curves toward an interior 113 of the frame portion 103 so as to pretension the tensioning portion 109, as would be understood by persons skilled in the art. When the tensioning segments 111 are pretensioned using the adjusting portion 112 relative to the bearing portion 108, a force directed outwards from the interior portion 113 is generated so as to counteract a deformation force acting on an exterior side wall of the longitudinal segments 102 in a direction toward the interior 113. For example, the adjusting portion 112 is configured to convert a rotary movement into tensile forces. For this purpose, bolt-like elements often engage with their external threads in internal threads of a base body of the adjusting portion 112.

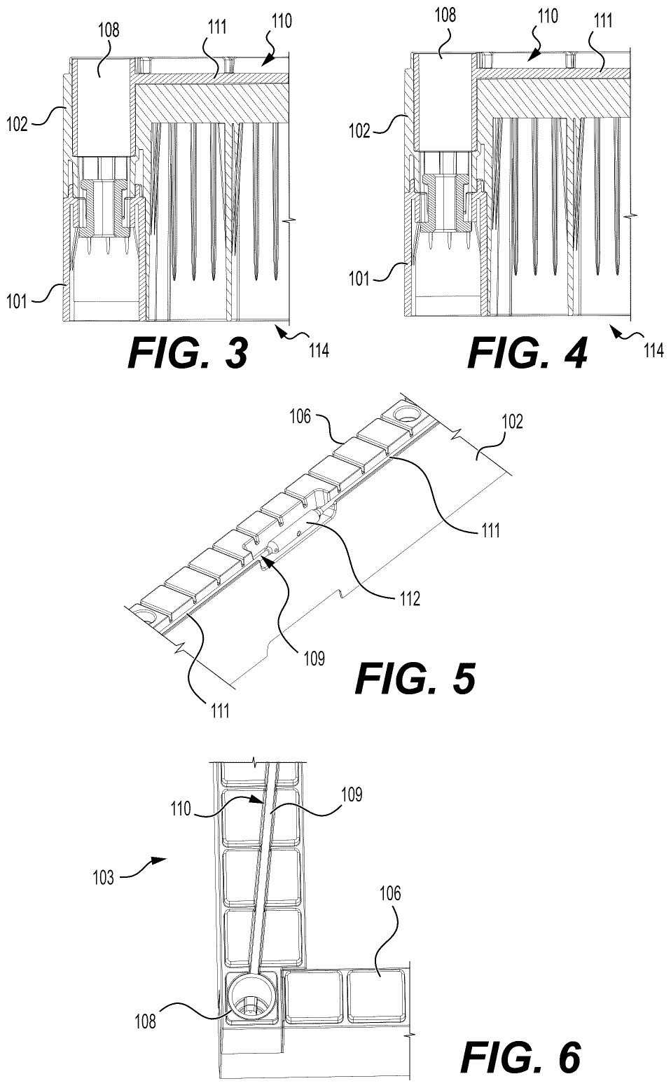

FIG. 3 shows an enlarged representation of a detail according to section C-C in FIG. 2. An exemplary coupling of the tensioning segment 111 with the bearing element 108 can be seen in particular. For example, the tensioning segment 111 may have an eyelet-like end into which the bearing element 108 engages. FIG. 4 shows an enlarged representation of a detail according to section CC (2) in FIG. 2.

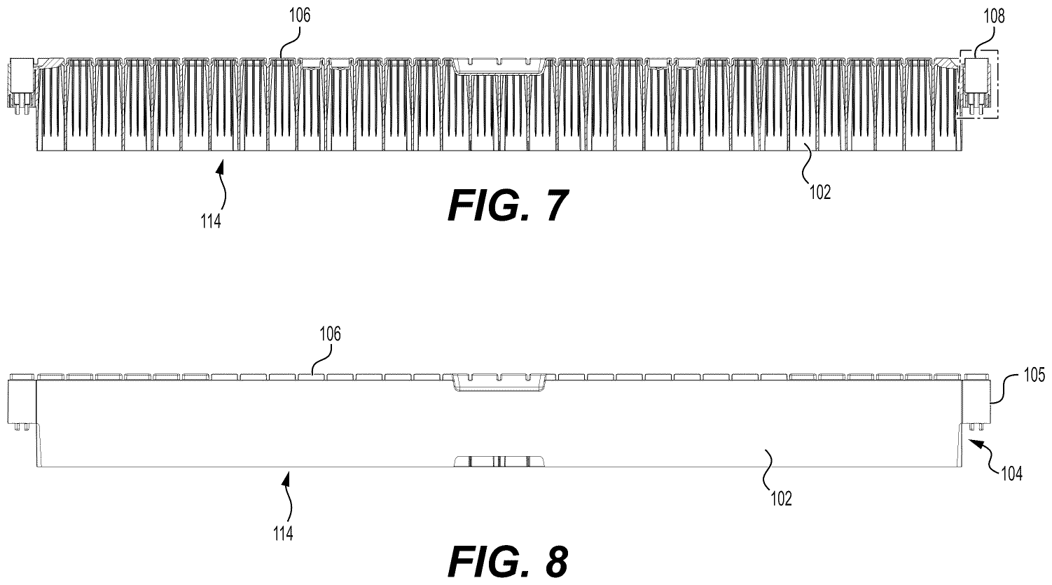

FIG. 7 shows a vertical cross-section through an exemplary longitudinal segment 102, and FIG. 8 shows a side view of the exemplary longitudinal segment 102. FIGS. 7 and 8 illustrate an exemplary arrangement of the engaging portion 106, for example, the elevations, and the corresponding engaging portion receiving portion, for example, depressions in the area of an underside 114 of the longitudinal segments 102.

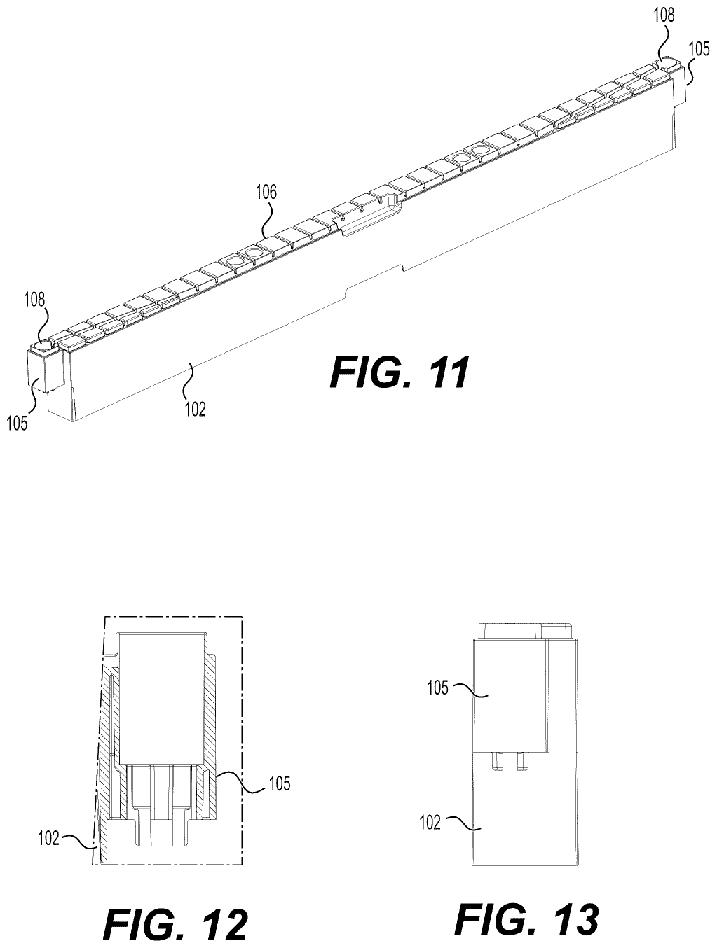

FIG. 11 shows a perspective representation of a longitudinal segment, which illustrates the coupling portion 105.

FIGS. 12 and 13 show an enlarged cross-sectional view and a side view of the coupling portion 105, respectively. The illustrations in FIG. 12 and FIG. 13 illustrate in particular that wall modules of different widths can be connected to one another using the coupling portion 105. According to the specifically illustrated embodiment, the coupling portion 105 can be used to connect module elements with a width of 50 mm to module elements with a width of 70 mm, for example. However, there is considerable scope for design depending on the dimensioning that is concretely available in each case.

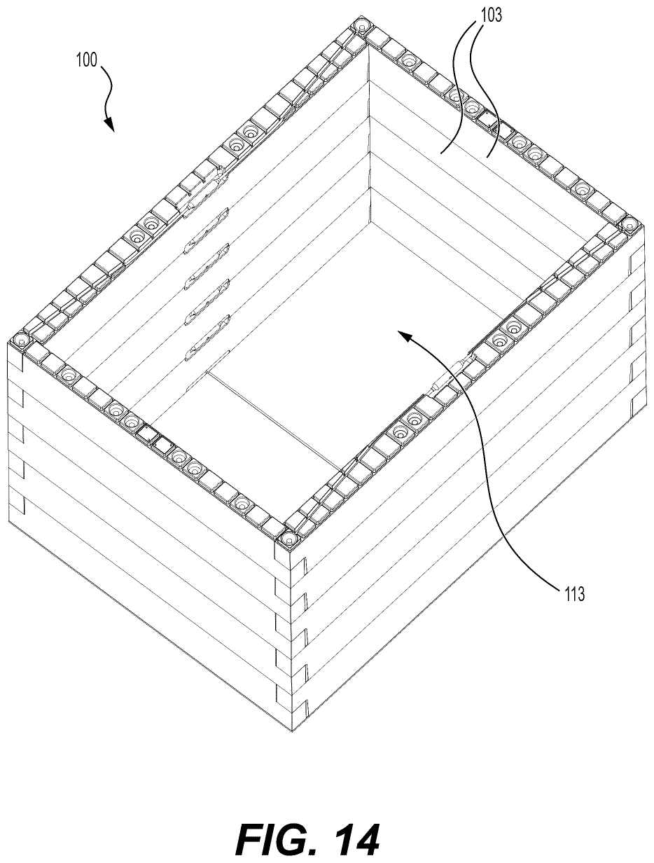

As illustrated in FIG. 14, a plurality of frame portions 103 may be arranged one above the other to form the ground shaft 100. The frame portions 103 are configured to enclose the interior 113 in a horizontal direction.

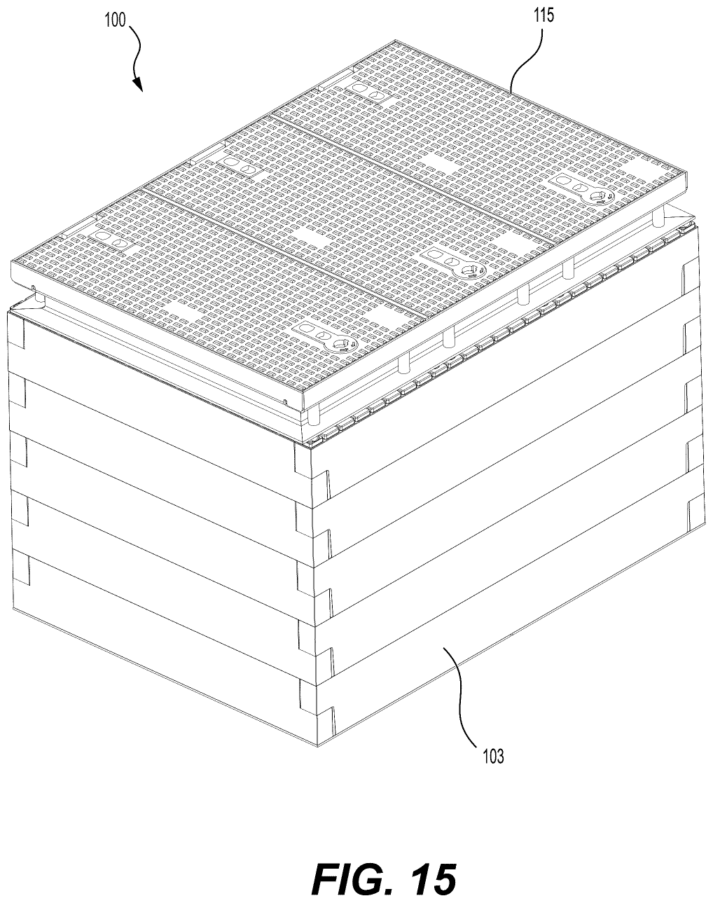

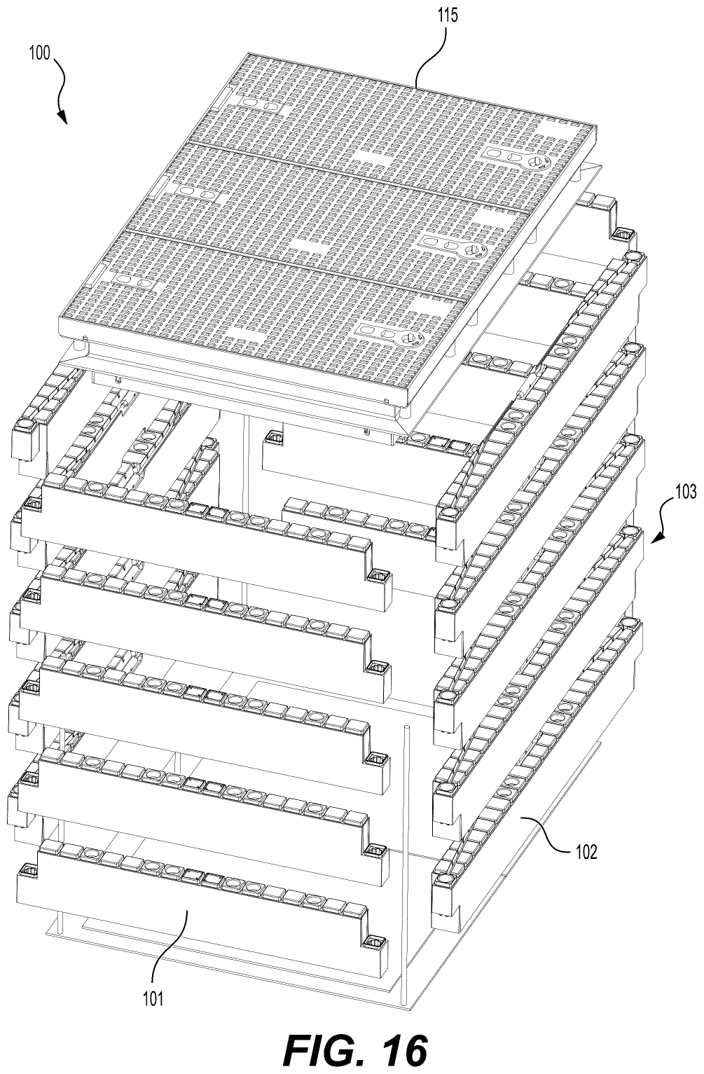

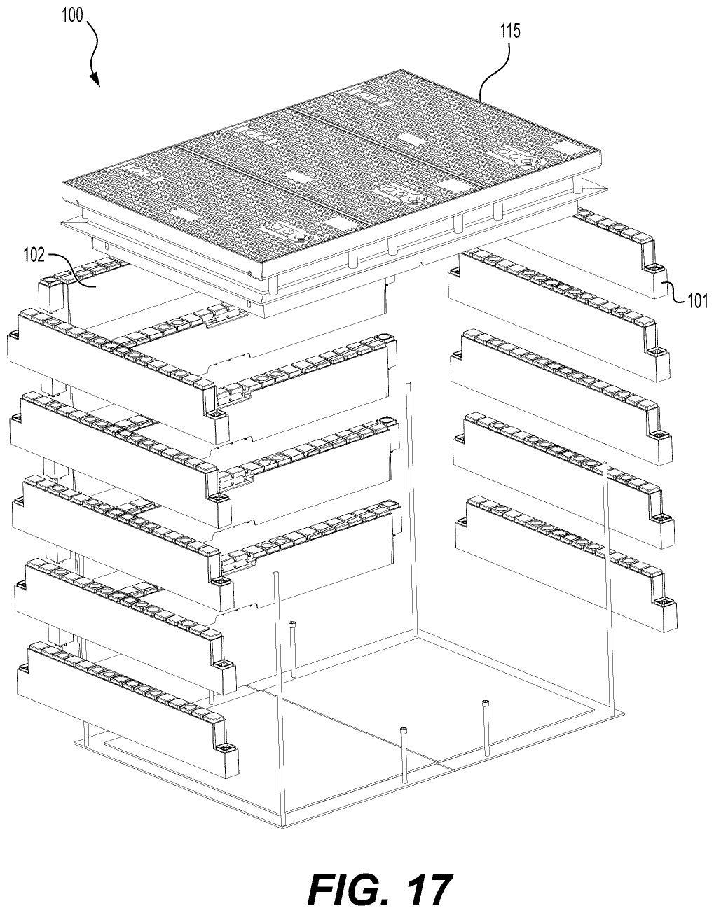

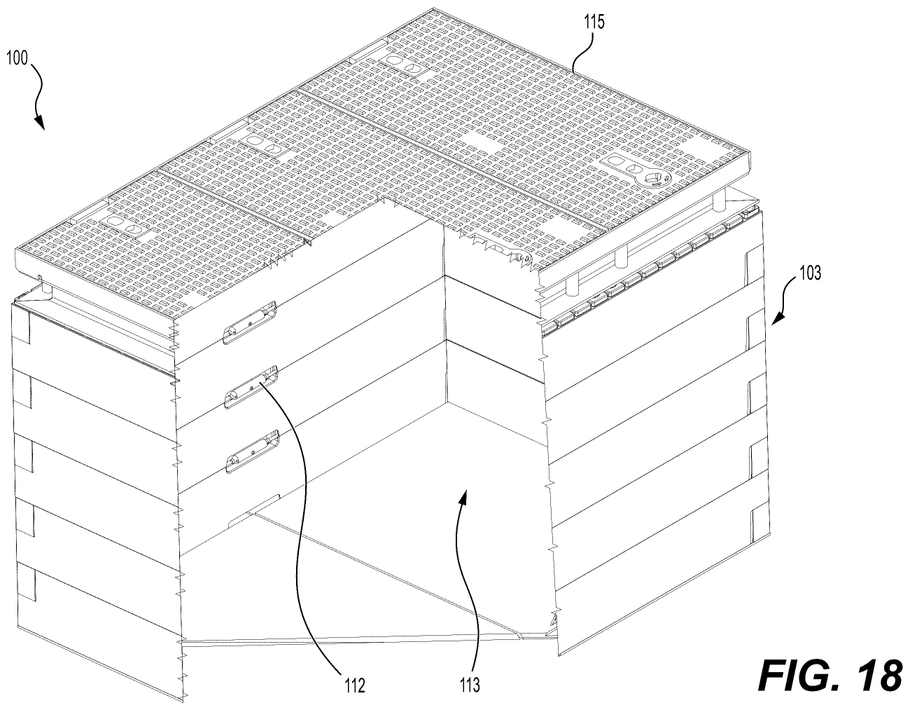

As shown in FIGS. 15-18, a cover portion 115 may be attached to a top surface of an uppermost frame portion 113. As illustrated, in some embodiments, the cover portion 115 may comprise a plurality of cover segments. The cover portion 115 is configured to enclose the interior 113 in a vertical or upward direction. The ground shaft may include alignment portions 116, for example, rods, pins, or the like that are configured to extend through the coupling portions 105 of the transverse segments 101 and the coupling portions 105 of the longitudinal segments 102. As illustrated, the coupling portion 105 of each of the transverse segments 101 is received by a receiving portion 104 disposed below a coupling portion 105 of each of the longitudinal segments 102, and the coupling portion 105 of each of the longitudinal segments 102 is received by a receiving portion 104 disposed above a coupling portion 105 of each of the transverse segments 101.

In the exemplary embodiments shown, the transverse segments 101 and the longitudinal segments 102 are each implemented as a one-piece component. In principle, however, it is also possible to subdivide the transverse segments 101 and the longitudinal segments 102 into separate modules, for example, separate modules that can be coupled together.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A ground shaft structurally configured to delimit a cavity and provide enhanced load-bearing capacity, comprising:
a first longitudinal wall portion and a second longitudinal wall portion configured to be spaced apart from one another and extend parallel to one another in a longitudinal direction;
a first lateral wall portion and a second lateral wall portion configured to be spaced apart from one another in the longitudinal direction and extend parallel to one another in a transverse direction that is perpendicular to the longitudinal direction;
wherein opposing ends of the first longitudinal wall portion are configured to be coupled with first ends of the first and second lateral wall portions, and opposing ends of the second longitudinal wall portion are configured to be coupled with second ends of the first and second lateral wall portions;
wherein the first longitudinal wall portion includes a tensioning portion and a receiving portion that is configured to receive the tensioning portion;
wherein the first ends of the first and second lateral wall portions are structurally configured to anchor opposing ends of the tensioning portion;
wherein the tensioning portion is configured to include an adjusting portion that is structurally configured to pretension the tensioning portion;
wherein at least a portion of the first longitudinal wall portion comprises plastic, and the tensioning portion comprises metal;
wherein the tensioning portion is structurally configured to counteract a deformation force acting on an exterior side portion of the first longitudinal wall in a direction toward an interior of the ground shaft so as to enhance load-bearing capacity of first longitudinal wall portion.

2. The ground shaft of claim 1, wherein the receiving portion comprises a groove in a top surface of the first longitudinal wall portion that is configured to curve toward the interior of the ground shaft so as to pretension the tensioning portion received therein.

3. The ground shaft of claim 1, wherein the adjusting portion is configured to generate a force directed outwards from the interior of the ground shaft.

4. The ground shaft of claim 1,
wherein the second longitudinal wall portion includes a second tensioning portion and a receiving portion that is configured to receive the second tensioning portion;
wherein the second ends of the first and second lateral wall portions are structurally configured to anchor opposing ends of the second tensioning portion;
wherein the second tensioning portion is configured to include an adjusting portion that is structurally configured to pretension the second tensioning portion;
wherein at least a portion of the second longitudinal wall portion comprises plastic, and the second tensioning portion comprises metal; and
wherein the second tensioning portion is structurally configured to counteract a deformation force acting on an exterior side portion of the second longitudinal wall in a direction toward the interior of the ground shaft so as to enhance load-bearing capacity of second longitudinal wall portion.

5. The ground shaft of claim 1, wherein first and second longitudinal wall portions and the first and second lateral wall portions are configured to be coupled with one another to form a continuous frame portion.

6. The ground shaft of claim 5, further comprising a second frame portion configured to be stacked with the frame portion,
wherein the second frame portion has first and second longitudinal wall portions and first and second lateral wall portions that are the same as the first and second longitudinal wall portions and the first and second lateral wall portions, respectively, of the frame portion.

7. A frame portion configured to provide enhanced load-bearing capacity for a ground shaft that is structurally configured to delimit a cavity, comprising:
a first longitudinal wall portion and a second longitudinal wall portion configured to be spaced apart from one another and extend parallel to one another in a longitudinal direction;
a first lateral wall portion and a second lateral wall portion configured to be spaced apart from one another in the longitudinal direction and extend parallel to one another in a transverse direction that is perpendicular to the longitudinal direction;
wherein opposing ends of the first longitudinal wall portion are configured to be coupled with first ends of the first and second lateral wall portions, and opposing ends of the second longitudinal wall portion are configured to be coupled with second ends of the first and second lateral wall portions;
wherein at least a portion of the first longitudinal wall portion comprises plastic;
wherein the first longitudinal wall portion includes a tensioning portion structurally configured to counteract a deformation force acting on an exterior side portion of the first longitudinal wall in a direction toward an interior of the frame portion so as to enhance load-bearing capacity of the first longitudinal wall portion.

8. The frame portion of claim 7, wherein the first longitudinal wall portion is configured to include a receiving portion that is configured to receive the tensioning portion.

9. The frame portion of claim 7, wherein the receiving portion comprises a groove in a top surface of the first longitudinal wall portion that is configured to curve toward the interior of the frame portion so as to pretension the tensioning portion received therein.

10. The frame portion of claim 7, wherein the first ends of the first and second lateral wall portions are structurally configured to anchor opposing ends of the tensioning portion.

11. The frame portion of claim 7, wherein the tensioning portion comprises metal.

12. The frame portion of claim 7, wherein the tensioning portion comprises plastic having greater tensile strength than the plastic of the first longitudinal wall portion.

13. The frame portion of claim 7, wherein the tensioning portion is configured to include an adjusting portion that is structurally configured to pretension the tensioning portion;

14. The frame portion of claim 13, wherein the adjusting portion is configured to generate a force directed outwards from the interior of the ground shaft.

15. The frame portion of claim 7, wherein the second longitudinal wall portion includes a second tensioning portion, and the second tensioning portion is structurally configured to counteract a deformation force acting on an exterior side portion of the second longitudinal wall in a direction toward the interior of the frame so as to enhance load-bearing capacity of second longitudinal wall portion.

16. The frame portion of claim 7, wherein first and second longitudinal wall portions and the first and second lateral wall portions are configured to be coupled with one another to form a continuous frame portion.

17. A ground shaft comprising:
the frame portion of claim 7;
a second frame portion configured to be stacked with the frame portion; and
wherein the second frame portion has first and second longitudinal wall portions and first and second lateral wall portions that are the same as the first and second longitudinal wall portions and the first and second lateral wall portions, respectively, of the frame portion.

18. A frame portion configured to provide enhanced load-bearing capacity for a ground shaft that is structurally configured to delimit a cavity, comprising:
a first longitudinal wall portion and a second longitudinal wall portion;
a first lateral wall portion and a second lateral wall portion configured to be coupled with the first longitudinal wall portion and a second longitudinal wall portion;
wherein at least a portion of the first longitudinal wall portion comprises plastic; and
wherein the first longitudinal wall portion includes a tensioning portion structurally configured to counteract a deformation force acting on an exterior side portion of the first longitudinal wall in a direction toward an interior of the frame portion so as to enhance load-bearing capacity of the first longitudinal wall portion.

19. The frame portion of claim 18, wherein the first longitudinal wall portion is configured to include a receiving portion that is configured to receive the tensioning portion.

20. The frame portion of claim 18, wherein the receiving portion comprises a groove in a top surface of the first longitudinal wall portion that is configured to curve toward the interior of the frame portion so as to pretension the tensioning portion received therein.

21. The frame portion of claim 18, wherein first ends of the first and second lateral wall portions are structurally configured to anchor opposing ends of the tensioning portion.

22. The frame portion of claim 18, wherein the tensioning portion comprises metal.

23. The frame portion of claim 18, wherein the tensioning portion comprises plastic having greater tensile strength than the plastic of the first longitudinal wall portion.

24. The frame portion of claim 18, wherein the tensioning portion is configured to include an adjusting portion that is structurally configured to pretension the tensioning portion;

25. The frame portion of claim 24, wherein the adjusting portion is configured to generate a force directed outwards from the interior of the ground shaft.

26. The frame portion of claim 18, wherein the second longitudinal wall portion includes a second tensioning portion, and the second tensioning portion is structurally configured to counteract a deformation force acting on an exterior side portion of the second longitudinal wall in a direction toward the interior of the frame so as to enhance load-bearing capacity of second longitudinal wall portion.

27. The frame portion of claim 18, wherein opposing ends of the first longitudinal wall portion are configured to be coupled with first ends of the first and second lateral wall portions, and opposing ends of the second longitudinal wall portion are configured to be coupled with second ends of the first and second lateral wall portions to form a continuous frame portion.

28. A ground shaft comprising:
the frame portion of claim 18;
a second frame portion configured to be stacked with the frame portion; and
wherein the second frame portion has first and second longitudinal wall portions and first and second lateral wall portions that are the same as the first and second longitudinal wall portions and the first and second lateral wall portions, respectively, of the frame portion.
